(19) United States
(12) Patent Application Publication
(10) Pub. No.: US 2004/0126104 A1
(43) Pub. Date: Jul. 1, 2004

(54) Kiosk having a light source

(76) Inventors: Tina M. Clark, Honeoye Falls, NY (US); Amy D. Enge, Spencerport, NY (US); Angelo F. Lisuzzo, Rochester, NY (US); Jo A. Gray, Webster, NY (US); Michael J. Hosey, Spencerport, NY (US); John R. Fredlund, Rochester, NY (US); Joseph A. Manico, Rochester, NY (US); Kenneth B. Martinez, Rochester, NY (US)

Correspondence Address: Thomas H. Close,, Patent Legal Staff,, Eastman Kodak Company, 343 State Street, Rochester, NY, 14650-2201, US

(21) Appl. No.: 10/666,385

(22) Filed: Sep. 19, 2003

Related U.S. Application Data
(60) Provisional application No. 60/412,218, filed on Sep. 20, 2002.

(51) Int. Cl. G03B 15/00

(52) U.S. Cl. 396/2

(57) ABSTRACT

A kiosk for capturing an image. The kiosk includes a housing having a width and a continuous curved surface; a digital image capture device adapted to capture an image, the image capture device disposed in a portal in the curved surface; a display disposed on the curved surface adapted to display the image captured by the image capture device; a light source disposed within the housing for illumination during the capture of an image by the image capture device, the image capture device being disposed intermediate the display and light source, the light source being configured along the width of the housing; and a data entry device adjacent the curved surface such that the distance from the digital image capture device to an outboard edge of the keyboard defines a minimum image capture distance.

### CROSS REFERENCE TO RELATED APPLICATIONS

This is a 111A Application of Provisional Application, Serial No. 60/412,218, filed on Sep. 20, 2002.

### FIELD OF THE INVENTION

The invention relates generally to the field of imaging and in particular to a kiosk adapted to capture an image.

### BACKGROUND OF THE INVENTION

There exists a need for an interactive kiosk which provides a source of entertainment for a user. Such an interactive kiosk can be placed at entertainment destinations, for example, theme parks, national parks, and malls.

### SUMMARY OF THE INVENTION

An object of the present invention is to provide an interactive kiosk which is a source of entertainment for a user.

This object is given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a kiosk having a digital image capture device and a light source for illumination during the capture of an image.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a diagram of an interactive kiosk in accordance with the present invention.

FIG. 2 shows a diagram of included functions of the kiosk of FIG.

FIG. 3 shows a side view of the kiosk of FIG. 1

FIG. 4 shows a side view of the kiosk of FIG. I illustrating the location of a camera.

FIG. 5 shows a diagram of the imaging chain of the kiosk in accordance with the present invention.

FIG. 6 shows an isometric view of a camera mount assembly in accordance with the present invention.

FIGS. 7-13 show the components of the camera mount assembly of FIG. 6.

### DETAILED DESCRIPTION OF THE INVENTION

The following is a detailed description of the preferred embodiments of the invention, reference being made to the drawings in which the same reference numerals identify the same elements of structure in each of the several figures.

The interactive kiosk of the present invention is an image capture kiosk, and can be used at entertainment destinations and other venues where users assemble. In a preferred embodiment, the kiosk is internet enabled, thereby providing a capability to print on-line or off-line, such as to a photofinishing system located adjacent to or remotely from the kiosk.

As will become apparent, the kiosk of the present invention offers users the ability to capture their image, perform simple image manipulations, and fulfill their image through a fulfillment system. In particular, the kiosk of the present invention allows a user to capture an image (i.e., the user takes a picture), image viewing (i.e., the user views the captured image on a display/monitor), image editing (i.e., the user uses different editing features to enhance the image), and image fulfillment (i.e., the user transmits the image to home, e-mail, printer, or the like). As such, the kiosk of the present invention provides for the features of capture, storage, display, manipulation, delivery, and deletion.

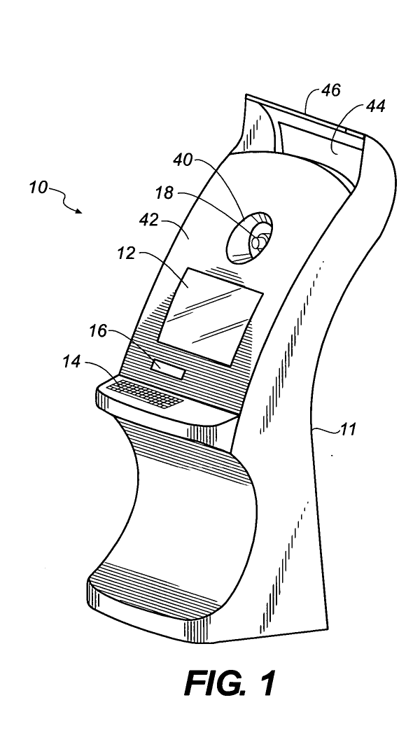

Referring to FIGS. 1-4, there is shown a kiosk 10 in accordance with the present invention. Kiosk 10 includes a housing 11 and a monitor or display 12 for displaying a digital image. Display 12 can be a touchscreen display, whereby a user can provide information and data to kiosk 10, or a data entry 10 device such as a keyboard 14 may be used to provide information and data. Kiosk can optionally include an input port 16 adapted to receive a digital storage device such as a memory card, memory stick, media card, compact flash card, floppy disk, compact disc, PictureCD, or the like as known to those skilled in the art. Kiosk 10 further includes a digital image capture device 18, such as a digital camera or video camera, for capturing an image in digital form which can be manipulated and/or stored in a digital file. (Hereinafter, image capture 18 is referred to as camera 18 for ease of discussion purposes only.) A digital file comprising a digital image can be transmitted to/from display kiosk 10 from/to another digital device such as a computer 21 or processing lab 23 (such as a photofinishing lab digital minilab, wholesale lab) over a communication network 20.

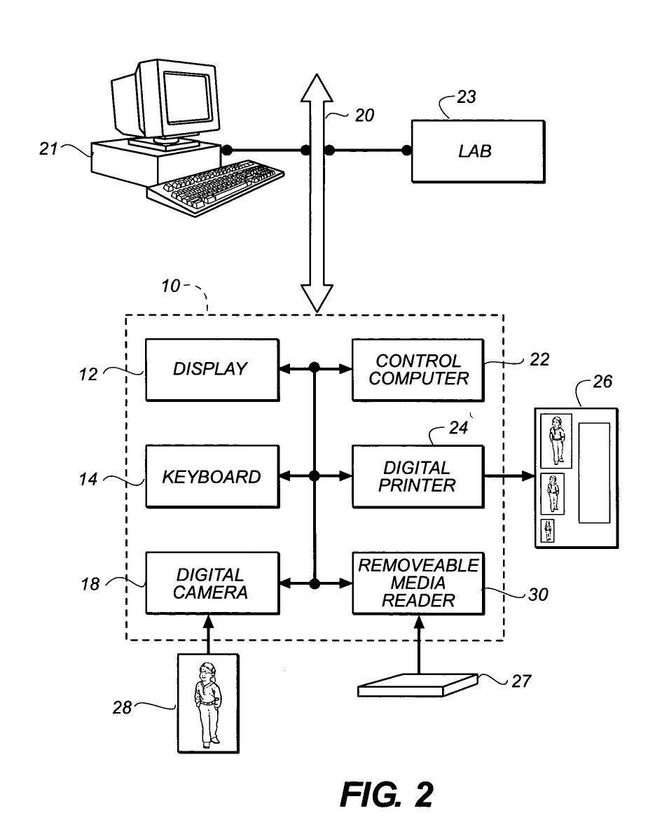

FIG. 2 generally shows a diagram of included functions of kiosk 10. As illustrated, kiosk 10 can include keyboard 14 and camera 18. A computer 22 typically manages the flow of information and functionality of the components of kiosk 10. Internal to display kiosk 10 can be a printer 24, an example of which is the Kodak Digital Science Model 8650 manufactured by Eastman Kodak Company. Printer 24 responds to commands of computer 22 for forming an image on a medium such as thermal or ink-jet paper. An example of an output image is illustrated in FIG. 2 at 26 formed from an image 28. One method of receiving a digital image is illustrated by a removable media reader 30 disposed internal to input port 16 for receiving removable media 27, for example, a memory card, floppy disk, compact disc, PictureCD, or other form of removable media used in transferring digital files. Kiosk 10 can optionally include means for recording audio, such as a microphone.

Camera 18 captures an image (i.e., a picture) which can be stored and displayed on display 12. The user can perform some manipulation transforms on the captured image or take/retake another image. If the picture is to be retaken, the current image is preferably deleted so that only one image is being acted on. Accordingly, kiosk 10 allows a user to manipulate the digital image displayed on display 12. For example, a user can rotate the digital image, zoom and crop the digital image. Preferably, the image is stored on computer 22 at the full resolution of the capture.

For entertainment purposes, when the user is manipulating the image viewed on display 12, the user views all image manipulations on the display as the user is making changes to the image. The image edits are stored in a script and are applied to the image for display, rendering and fulfillment. The image itself is not modified unless and until it is rendered for fulfillment. The image can be transmitted to an e-mail or user account wherein the rendered image is delivered to the user's specified locations.

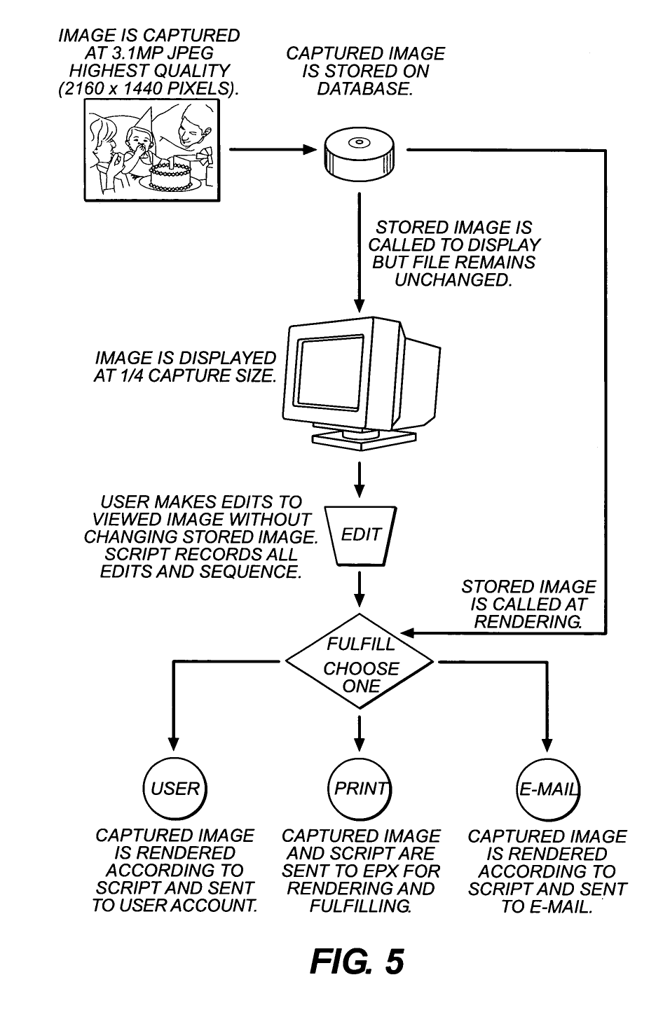

When the user has completed the session of use, the image and edits are stored for a discrete/predetermined period of time. The images can be held for a week to perform trouble-shooting. The image and script are then deleted from the database. The imaging chain is generally shown in FIG. 5.

With regard to camera 18, camera 18 preferably provides both video feed and image capture. It is also preferred that a separate, off-camera flash unit is used so as to maximize the kiosk's modularity. For example, if separate units, the flash and camera can be easily replaceable upon failure. Further, the placement of the camera and flash are arranged in kiosk 10 so as to maximize the image quality of the captured image. It is recognized that a separate off-camera flash unit requires that the camera have a flash-sync port/adapter.

Camera 18 can be any digital camera that provides acceptable image quality, preferably, 3.1 mega pixels of resolution. A suitable camera is the DC 4800 camera available from Eastman Kodak Company, which offers 3.1 mega pixel resolution, video feed, and a flash-sync port for the external flash. Camera firmware modifications may be performed to provide for optimal video and image capture performance.

Camera 18 is shown disposed with an aperture/portal 40 of a front surface 42 of kiosk 10, as best seen in FIGS. 1 and 4. As arranged, camera 18 captures a scene disposed in front of kiosk 10. For example, an image of the user standing in front of kiosk 10 will be taken when camera 18 is actuated. This image will be shown on display 12, whereby the user can access various image manipulation transforms for manipulating and transforming the captured image. Further description on the image manipulation transforms is described below.

As is shown in FIG. 1, kiosk 10 has a configuration comprising various curves. Such curvature provides for a particular feature of the present invention, as best shown in FIG. 4. A typical camera has a focal depth wherein objects are in focus. Objects closer than the focal depth may be blurry, and objects farther than the focal depth may be blurry. For kiosk 10, the user preferably stands at least a distance D1 from camera 18, and stands within a distance between D1 and (D1+D2). For Applicant's particular example of a DC4800, the requirement is for a user to be 2-4 feet from camera 18. To arrange this proper positioning of the user while providing a kiosk which is aesthetically pleasing, Applicant has provided a continuous curvature to front surface 42 of kiosk 10 such that the distance from camera 18 to an edge 48 of keyboard 14 is a distance D1. As such, the user cannot stand closer than distance D1, thereby promoting the capture of a sharp image of the user. For Applicant's particular example, distance D1 is approximately 2 feet. Thus, the angle of curvature of front surface 42 relative to an axis Z is determined to be a distance D3 such that the sum of distance D3 and a width of keyboard D4 is equal to distance D1 (i.e., D1=D3+D4). This distance is used since the user of kiosk 10 typically stands adjacent keyboard 14 to operate kiosk 10. As such, the curvature of front surface 42 provides a functional purpose (i.e., place user at proper image capture location) yet provides a visually pleasing and appealing structure. Still yet, the keyboard continues to be accessible at all times. Providing an appealing structure is critical since kiosk 10 is intended for entertainment, and therefore needs to be attractive to the user.

Kiosk 10 can be placed in a variety of venues. According lighting during the capture of an image is critical to achieving good image quality. Accordingly, it is important the lighting (also referred to as a light source or flash) illuminate subjects evenly for subjects positioned distance D2 from keyboard edge 48 (i.e., D1<distance<D1+D2). As indicated above, for Applicant's particular example, the light source should illuminate subjects evenly for a range from about 2 feet to about 4 feet. Further, the light source for kiosk 10 should not create red-eye or significant glare on glasses being worn by the user. Kiosk 10 of the present invention is configured to reduce red-eye and glass glare.

Applicant has determined that red-eye and glass glare can be reduced/eliminated if the light source is spaced at least 8 inches from a lens of camera 18. Accordingly, a light source 44 of kiosk 10 is spaced at least 8 inches from camera 18.

A light source external to camera 18 provides control of the capture lighting conditions. An external flash in conjunction with a reflector provides softer shadows and more even illumination. Therefore, kiosk 10 preferably includes a reflector 46. Light source 44 preferably provides a minimum of 120 ft-cd. This is equivalent to the amount of high office lighting.

The light source must be able to be synced to camera 18 for firing during image capture. The external flash must also have an AC adapter for power. A Vivitar 283 flash is a suitable example.

An auto-thyristor can be employed to modulate the flash power. The auto-thyristor will give automatic control of the power of the flash for subjects in the range of 2-4 feet. Preferably, an auto-thyristor would be mounted adjacent to and parallel with the camera lens.

The material comprising reflector 46 is selected so as to sufficiently diffuse the light provided by light source 44 to produce soft shadows. As shown in FIGS. 1, 3, and 4, reflector 46 is positioned above camera 18 and at a distance from camera 18 sufficient to minimize flash reflection in subjects wearing glasses. The flash reflection should at least not be in the center of the glasses or obliterating the eyes in the capture for subjects with normal glasses who are looking directly at the camera. For Applicant's particular example, camera 18 preferably includes an effective dark area of at least 8″ around the entire camera lens to eliminate/minimize reflection on glasses. Positioning camera 18 within portal 40 promotes the effective dark area. Further, comprising portal 40 of a dark color promotes the effective dark area. Since the radius of portal 40 is typically not 8 inches in diameter, the portion of front surface 42 disposed within 8 inches of camera 18 can be of a neutral color (for example, light gray color) thereby promoting the effective dark area. Bright colors for front surface 42 are preferably not employed.

One suitable reflector material is Photoflex white-silver light panel. Other reflector material may be used, preferably photographic white. The size and shape of the reflector material can be modified to conform to the aesthetics of the kiosk.

In addition, to reduce glass glare, a matte surface is provided to front surface 42 of kiosk 10 to diffuse the light from light source 44 and reduce reflections from front surface 42. Still further, the angular orientation of front surface 42 provides for less reflection and therefore, also assists in the reduction of red-eye and glass glare. That is, the curvature of front surface 42 helps scatter/diffuse the light.

To increase the amount of illumination, display 12 can be configured to display a light color, preferably white just prior to (and/or during) the time of flash (i.e., the time the image is captured by camera 18). Due to the short exposure time of display 12 to displaying this light color, display 12 is not adversely affected. The increased intensity promotes reduced red-eye and glass glare.

Secondary illumination of the subject from below the camera/subject can be provided. This secondary lighting will assist in the illumination of subjects wearing hats.

Additional lighting can be incorporated into kiosk 10 to illuminate the subject for video feed under low-ambient lighting conditions. Preferably, a minimum of 50 ft-cd is employed. Applicants have employed three halogen side lights with diffusers to fulfill this need. Alternatively, 2-20″ Osram Deluxe L55W-12-950 bulbs can be employed.

Kiosk 10 can be employed in a variety of venues with uncontrolled ambient lighting conditions and unique backdrop conditions. Background areas of highly saturated colors may cause white balance issues during image capture.

Once the image is captured, image manipulation transforms are provided for the user to interact with the captured image. For example, the user can swirl the image; the user can add/position/resize/rotate pre-created image clips (mustache, eyes, speech bubbles, caricatures, etc) to the captured image; the user can morph the subject into an animal. It is recognized that various image manipulations transforms are well known, and can be implemented for use with kiosk 10 by those skilled in the art.

When adding captions to the captured image or when sending a message with the manipulated image (for example, when sending via e-mail), it may be desirable to remove profanity or other words which may be considered offensive to a recipient. Accordingly, it is preferred that computer 22 includes a spell checker for determining such offensive words. For example, the spell checker can comprise a table of words with which to compare the word(s) entered by the user to kiosk 10. When an offensive word is encountered, computer 22 can provide a message to the user, for example, indicating that an alternate word should be selected. Computer 22 might delay the viewing of a word until the entered word is first checked by the spell checker so that the offensive word is not viewed by other individuals who may be watching display 12 of kiosk 10.

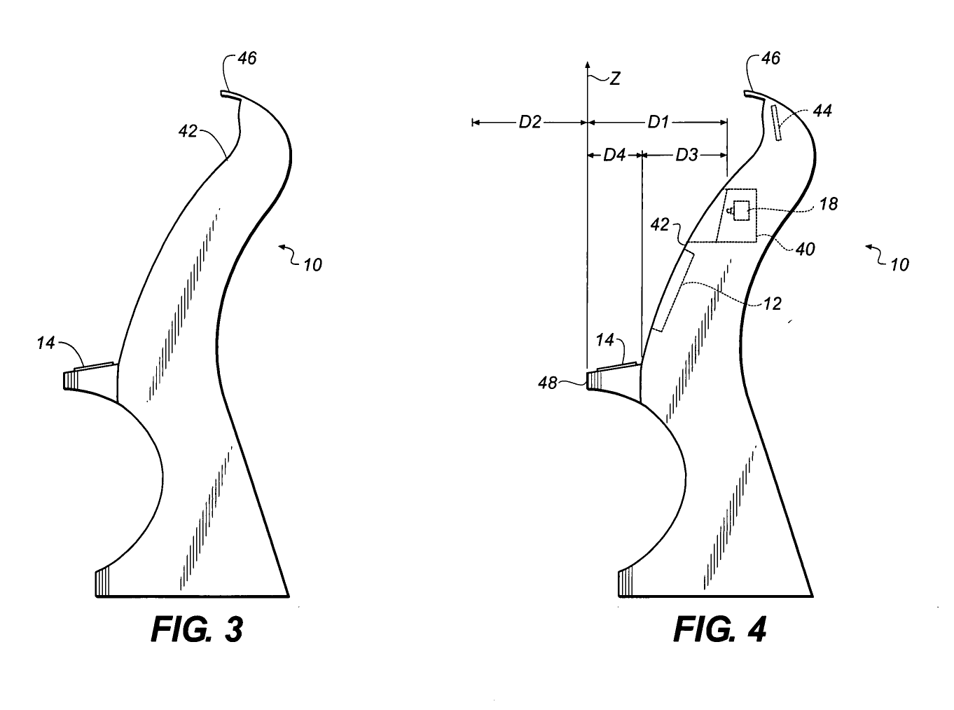

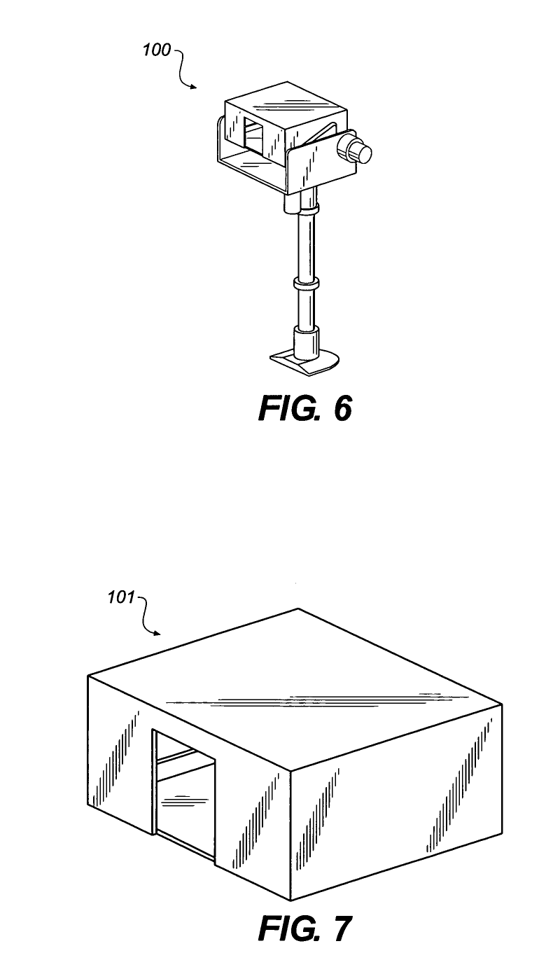

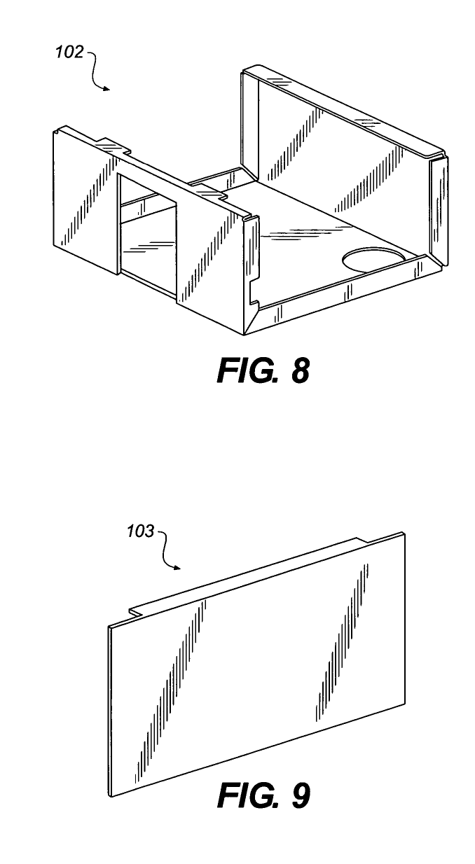

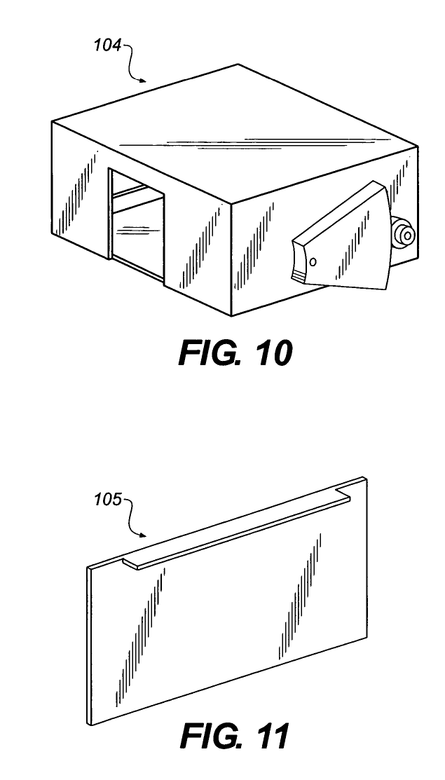

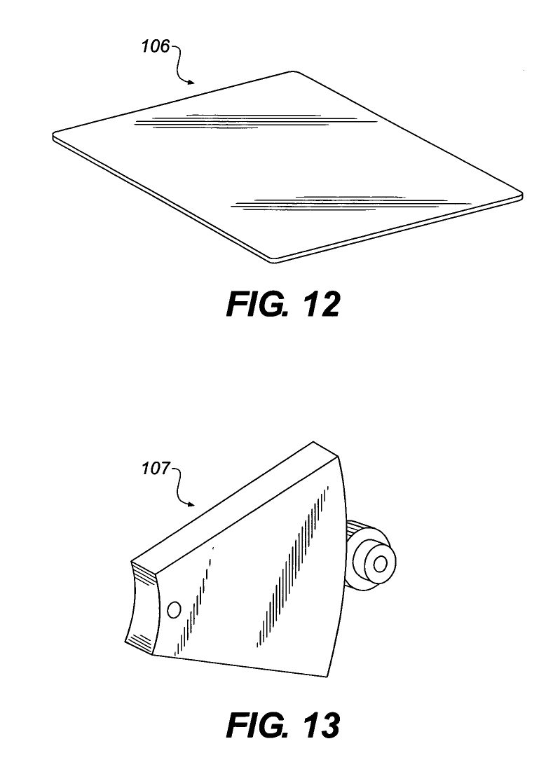

Camera 18 is configured to translate and tilt within portal 40. This allows camera 18 to accommodate various subject heights, and to zoom. FIGS. 6-13 show a mechanical system for moving and tilting camera 18 within portal 40. FIG. 3 shows a camera mount assembly 100 on which camera 18 is mounted. FIGS. 7 through 13 show the components of assembly 100, specially: box assembly 100, box base 102, box gear plate 103, box gears 104, box side plate 105, box top panel 106, and gear segment and pinion 107. The actuation of camera mount assembly 100 to translate/tilt camera 18 can be accomplished by a user by means known to those skilled in the art. For example, keyboard 14 can include a joystick, 4-way motion pad, or buttons to affect motion. Alternatively, a touchscreen on display 12 can be employed. As camera 18 is being moved by assembly 100, the changing image can be displayed on display 12 to allow the user to adjust camera 18 to obtain a desired image.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

Parts List

10 kiosk

11 housing

12 display

14 keyboard

16 input port

18 digital image capture device

20 communication network

21 computer

22 computer

23 processing lab

24 printer

26 output image

27 removable media

28 input image

30 removable media reader

40 portal

42 front surface

44 light source

46 reflector

48 edge

100 camera mount assembly

101 box assembly

102 box base

103 box gear plate

104 box gears

105 box side plate

106 box top panel

107 gear segment and pinion

What is claimed is:

1. An imaging kiosk, comprising:
a housing comprising:
a continuous curved front surface;
a digital image capture device, disposed in a recess in the front surface, for capturing a digital image of the user;
a display, disposed in the front surface, for displaying the captured digital image;
a single light source providing reflected and diffused lighting and being disposed adjacent the housing such that the digital image capture device is disposed intermediate the display and the light source; and
a reflector for reflecting the light emitted from the light source, the reflector disposed proximate the light source such that the light source is intermediate the digital image capture device and at least a portion of the reflector.

2. The imaging kiosk according to claim 1, wherein the housing has a width, and the single light source and reflector are disposed across the width of the housing.

3. The imaging kiosk according to claim 1, wherein the light source provides a minimum of 120 ft-cd.

4. The imaging kiosk according to claim 1, wherein the light source is spaced at least 8 inches from the digital image capture device.

5. The imaging kiosk according to claim 1, wherein the recess is comprised of a dark color.

6. The imaging kiosk according to claim 1, further comprising a data entry device disposed proximate the front surface of the housing, the data entry device being arranged so as to be intermediate the user and the housing.

7. The imaging kiosk according to claim 6, wherein the data entry device has an edge disposed opposite the front surface of the housing, and a distance from the digital image capture device to the edge defines a minimum image capture distance.

8. The imaging kiosk according to claim 7, wherein the minimum image capture distance is 2 feet.

9. The imaging kiosk according to claim 1, wherein the single light source includes a flash operable during the capture of the digital image.

10. The imaging kiosk according to claim 9, further comprising a processor and software operating on the processor to control the operation of the flash.

11. The imaging kiosk according to claim 9, further comprising an auto-thyristor.

12. The imaging kiosk according to claim 11, wherein the digital image capture device comprises a lens, and the auto-thyristor is disposed proximate the digital image capture device parallel to the lens.

13. The imaging kiosk according to claim 1, wherein the reflector is comprised of Photoflex.

14. The imaging kiosk according to claim 1, wherein the front surface comprises a matte finish.

15. The imaging kiosk according to claim 1, wherein the front surface comprises a neutral or white color.

16. The imaging kiosk according to claim 1, wherein the display displays a light or white color substantially simultaneously with the capture of the digital image of the user.

17. The imaging kiosk according to claim 1, further comprising means for moving the digital image capture device within the recess relative to the housing.
